(19) United States
(12) Patent Application Publication
(10) Pub. No.: US 2024/0380018 A1
(43) Pub. Date: Nov. 14, 2024

(54) METHOD FOR HEATING A BATTERY, AND A BATTERY

(71) Applicant: MERCEDES-BENZ GROUP AG, Stuttgart (DE)

(72) Inventors: Lukas RUBACEK, Leinfelden-Echterdingen (DE); Hansen CHANG, Stuttgart (DE); Anselm MÜLBERGER, Wernau (Neckar) (DE)

(21) Appl. No.: 18/294,687

(22) PCT Filed: Jul. 22, 2022
(86) PCT No.: PCT/EP2022/070681

§ 371 Date: Feb. 2, 2024

(30) Foreign Application Priority Data
Aug. 5, 2021 (DE) 10 2021 004 055.4

(51) Int. Cl. H01M 10/637; H01M 10/615; H01M 10/625; H01M 10/6571

(52) U.S. Cl. CPC H01M 10/637; H01M 10/615; H01M 10/625; H01M 10/6571

(57) ABSTRACT

A method for heating a battery having individual battery cells employs semiconductor switching elements arranged between the poles of the individual battery cells. The individual battery cells are short-circuited to be heated via the semiconductor switching elements. A time phase with short-circuited individual battery cells and a time phase with individual battery cells that are not short-circuited alternate.

### BACKGROUND AND SUMMARY OF THE INVENTION

Exemplary embodiments of the invention relate to a method for heating a battery constructed from individual battery cells, as well as to a battery formed as a traction battery which is set up to carry out the method.

Batteries are increasingly being used in at least partially electrically driven vehicles. The batteries are usually made up of a large number of individual battery cells, which are realized as individual battery cells in lithium-ion technology, for example. Such batteries require a certain operating temperature in order to function properly. At very low temperatures, which lie significantly below this operating temperature, for example at temperatures lying significantly below the freezing point, it is therefore necessary to heat the individual battery cells in order to maximize their performance. A common construction in this case is the use of an electric heater, which is described in WO 2019/137670 A1, for example. Heating mats are inserted between the individual battery cells and the batteries are heated electrically. The heat must then pass through a battery housing into the interior of the battery, making this a very complex, time-consuming, and energy-intensive way of heating batteries.

It is also known from the further prior art with regard to such batteries to connect the individual battery cells with each other via corresponding switches, in particular semiconductor switches, in order to create so-called cell balancing, i.e., charge equalization between the individual battery cells, for example, which may be charged or discharged to different degrees. In this context, reference can be made, for example, to EP 2 559 094 B1 or, on a similar topic, to WO 2019/214824 A1.

US 2007/0160900 A1 discloses a generic process in which the individual battery cells are heated via time-limited short circuits. CN 1 12 531 855 A describes a construction which would also enable such a procedure in principle.

Reference can also be made to US 2015/0380697 A1 for further prior art. Flexible line elements on a film are described therein.

Exemplary embodiments of the present invention are directed to a method for heating a battery constructed from individual battery cells, which method is improved compared to the use of known heating mats, as well as to a battery suitable for the method.

The method according to the invention for heating a battery constructed from individual battery cells uses semiconductor switching elements arranged between the poles of the individual battery cells, similarly to the cell balancing structures in the above-mentioned prior art. In the method according to the invention, the individual battery cells are short-circuited to be heated via the semiconductor switching elements, wherein time phases with short-circuited individual battery cells and time phases with individual battery cells that are not short-circuited alternate. The short-circuiting of the individual battery cells ensures that the electrical energy from the individual battery cell itself is used to generate heat in the individual battery cell, specifically at its internal resistance. This has the decisive advantage that heat can be generated with minimal energy input at exactly that point where it is needed to heat the individual battery cells, specifically inside the individual battery cells themselves. Independent of the heat conduction through a housing of the individual battery cells, independent of any heat transfer from a cooling medium to the individual battery cell or the like, the heating of the individual battery cell is thus effected exactly where it is ultimately needed. The method according to the invention for heating the individual battery cells is therefore extremely efficient and can be easily realized with minimal additional effort, especially if semiconductor switching elements for cell balancing are already present.

According to the invention the time phase with the short-circuited individual battery cells reaches up to 100 ms, wherein the time phase with the individual battery cells that are not short-circuited is in the range of from 10 to 20 s. According to an advantageous development, the time phase with individual battery cells that are not short-circuited is in the range of from 5 to 15 s.

Even in this relatively short time period of up to 100 ms, a considerable amount of heat can be generated by short-circuiting the individual battery cell. Subsequently, the short-circuiting is then paused in order to then short-circuit the individual battery cell again.

According to an extremely favorable development of the method according to the invention, it can also be provided that the time phase with the individual battery cells that are not short-circuited is made up of a first time period of relaxation and a subsequent second time period of charging, wherein the time period of charging lasts longer than the time period of relaxation. In the phase in which the individual battery cell is not short-circuited, it is therefore given a time period of relaxation in which the charges can be evenly distributed in the individual battery cell again. In the next phase in which the individual battery cell is not short-circuited, the battery is then charged, so that the overall state of charge of the battery at least does not deteriorate despite the heating process and can even be increased by charging the individual battery cells.

According to a very favorable development of the method according to the invention, the semiconductor switching elements are selected in such a way that they have a lower internal resistance than the internal resistance of the individual battery cell assigned to each of them, so that the majority of the heat generated at the electrical resistance is generated inside the individual battery cell and not in the region of the semiconductor switching elements.

The semiconductor switching elements themselves can be realized in almost any way, for example as thyristors, IGBTs or similar. In particular, MOSFETs are to be used here.

The battery according to the invention is now designed as a traction battery for at least partially electrically driven vehicles, for example hybrid vehicles or battery electric vehicles. It has an interconnection of its individual battery cells and a controller which are set up to carry out the method described above.

Such a battery can therefore have a suitable interconnection of the individual battery cells via semiconductor switches such as MOSFETs in order to implement the method accordingly.

In the battery according to the invention, each of the individual battery cells is assigned three semiconductor switching elements that can optionally or jointly connect the poles of the respective individual battery cell with a positive busbar, a negative busbar or the respective other pole of the adjacent individual battery cell. The individual battery cells can therefore have three semiconductor switching elements. One element can connect the adjacent and reversely polarized poles of adjacent individual battery cells accordingly in order to realize overall a series circuit of the individual battery cells within the battery or a module of the battery. The other elements can then be used to connect the respective positive pole to a positive busbar and the respective negative pole to a negative busbar. Overall, the individual battery cells can be connected in series, for example, to charge and discharge the individual battery cells. If these semiconductor switching elements are opened for the series connection of the individual battery cells and all positive poles are connected to the positive busbar and all negative poles to the negative busbar, then the individual battery cells can each be short-circuited in order to implement the heating according to the method, as described above.

According to the invention, the semiconductor switching elements are formed on a flexible conductor foil. Such a flexible conductor foil with the semiconductor switching elements arranged on it is a space-saving structure that can be integrated relatively easily into the overall battery structure.

According to a further very advantageous embodiment of the battery according to the invention, it can now further be provided that a respective further semiconductor switching element is arranged in the positive busbar and the negative busbar between the connections to the semiconductor switching elements of the respective individual battery cell. This makes it possible, for example, to disconnect individual battery cells from the overall battery assembly in order to bypass defective cells, for example. Furthermore, such an interconnection with five semiconductor switching elements assigned to each of the individual battery cells can also be used to implement the cell balancing described in the aforementioned prior art, i.e., the charge equalization between the individual battery cells of the battery.

An extraordinarily favorable development of the battery according to the invention can now provide for the individual battery cells to be formed as prismatic cells with electric poles arranged on opposite side edges, wherein the electric poles of adjacent individual battery cells are connected to the semiconductor switching elements via the flexible conductor foil. Such a construction is particularly simple and efficient and can use the flexible conductor foils to connect the poles of the individual battery cells on the one hand and integrate the necessary switching elements directly into this connection on the other hand.

In particular, according to a very advantageous development of the battery according to the invention, it can be provided that the individual battery cells are stacked with the flexible conductor foil placed in between and connected to form a battery module or the battery, for example are clamped in a housing or between end plates. The flexible conductor foil can then essentially extend in a Z-shape between the surfaces of the battery so that hardly any additional installation space is required for the structure. If heat losses now occur in the area of the semiconductor switching elements, in particular during the short-circuiting for heating the battery, then these also occur directly in the area of the individual battery cells, not in their interior, but between two respectively adjacent individual battery cells, so that the heat loss generated here can ultimately also contribute to the heating of the battery.

Further advantageous embodiments of the method according to the invention and of a battery according to the invention for carrying out the method also result from the exemplary embodiments, which are described in more detail below with reference to the figures.

### BRIEF DESCRIPTION OF THE DRAWING FIGURES

Shown here are:

FIG. 1 a schematic view of a first possible embodiment of a battery for carrying out the method according to the invention;

FIG. 2 a representation of the voltage and the current for a short time period during the method according to the invention;

FIG. 3 a schematic representation of the associated heating in a diagram;

FIG. 4 a diagram with a schematic representation of the charging state of an exemplary individual battery cell, during the method;

FIGS. 5a-5d representations of a possible construction of individual battery cells with their interconnection in a plurality of manufacturing steps; and

FIG. 6 an alternative embodiment of the battery analogous to the representation in FIG. 1.

### DETAILED DESCRIPTION

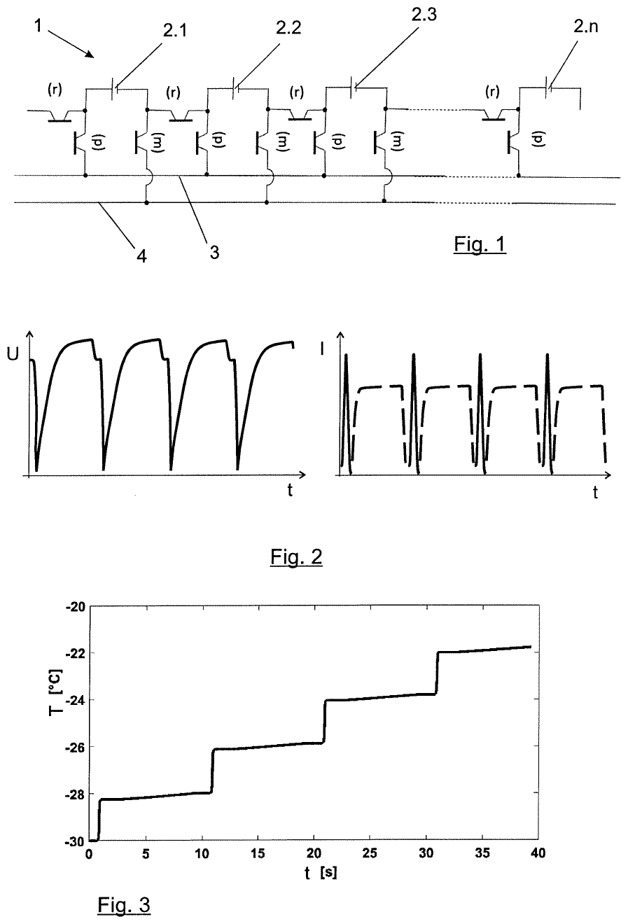

In the representation of FIG. 1, the electric interconnection of an exemplary battery 1 is represented schematically. It consists of a plurality of individual battery cells 2.1 to 2.n, wherein the adjacent reversed poles of each of the individual battery cells 1 can each be connected in a switchable manner via a semiconductor switch, such as a MOSFET. These semiconductor switches are referred to with (r). Additionally, each positive pole of each of the individual battery cells 2.1 to 2.n is connected via a semiconductor switch, for example again a MOSFET, with the reference (p) to a positive busbar 3 and each negative pole is connected via a semiconductor switch (m) to a negative busbar 4.

The internal resistance of each of the individual battery cells 2.1 to 2.n can now be used to self-heat the individual battery cells 2.1 to 2.n in the battery 1. Therefore, all three semiconductor switching elements (r), (p), (m) are transferred into the activated state, whereby a short circuit of the individual battery cells 2.1 to 2.n is achieved. If the semiconductor switching elements (r), (p), (m) are chosen so that their own resistance in series is less than the internal resistance of the individual battery cell 2.1 to 2.n, the heat produced by the short circuit will drop almost exclusively at the internal resistance of the individual battery cell 2.1 to 2.n and also heat the cell directly where the heat is required.

The semiconductor switches (p) and (m) are then correspondingly disconnected for charging and discharging the battery 1, so that only the series connection of the individual battery cells 2.1 to 2.n is maintained by the semiconductor switch (r).

For efficient yet gentle heating of the battery 1, the system now switches between these two states. A short circuit of the individual battery cells 2.1 to 2.n is therefore always generated for an initial time phase, followed by a time period for relaxation. The time period for the short circuit can therefore preferably be between 1 ms and 100 ms, the time period for the relaxation can be multiple seconds, for example 1 to 5 s, in particular approx. 1.5 s. In both diagrams of FIG. 2 an exemplary process is represented, by which the individual battery cells 2.1 to 2.n have been loaded with a respective low external resistance in the order of 10 W for 50 ms, for example. This is followed by relaxation for approx. 1.5 s, followed by charging of the individual battery cells 2.1 to 2.n for approx. 7 s. This then leads to the behavior illustrated by the diagrams in FIG. 2. The diagram on the left exhibits the voltage U of an individual battery cell 2.1 to 2.n over time t, while the diagram on the right exhibits the current I over time t. Discharging, i.e., ultimately of the short circuit, is exhibited with a solid line and charging with a dashed line within the diagram. The voltage drops slightly during the short circuit compared to the voltage during charging and then falls to almost zero during the relaxation phase. After relaxation, as can be clearly seen in particular from the current-time diagram on the right, charging takes place at a constant current, so that the voltage increases accordingly before the whole process can start again.

The result is that the respective individual battery cells 2.1 to 2.n heat up, as can be seen from the temperature (T) diagram over time t in FIG. 3. Essentially, the temperature increases in steps, as the individual battery cell 2.1 to 2.n heats up relatively significantly during the short circuit, whereas during the following charging process, the temperature also increases, however only minimally in comparison to the temperature increase during the short circuit. In the represented exemplary embodiment, the temperature has risen by approx. 8 K within approx. 40 s from a starting temperature of −30° C., further heating up to an operating temperature of 40° C., for example, would therefore require a time period of approx. 250 s with an average linear temperature rise which occurs here over time. The battery 1 can thus be heated with the method within a few minutes from extremely low temperatures up to a suitable operating temperature.

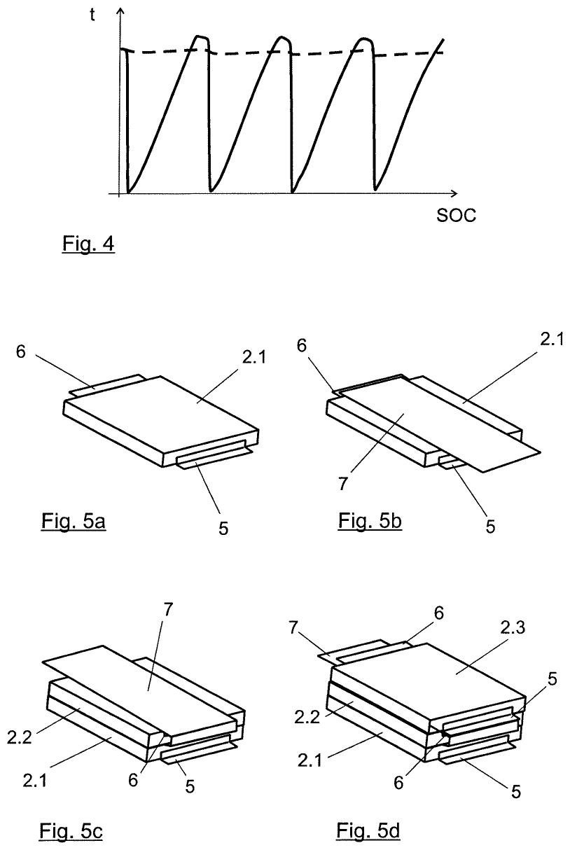

The charging behaves as shown in the diagram in FIG. 4, which exhibits the time t over the state of charge SOC. During the short circuit, the surface charges are predominantly used up, resulting in the behavior of the state of charge on the surface shown by the solid line. During the relaxation and during the charging, these charges are equalized again and are replenished so to speak from the inside of the individual electrodes of the battery 1 and are thus available again in the surface area for the next short circuit.

An exemplary construction for structural realization of a battery 1, as it is schematically indicated in particular in FIG. 1, is now correspondingly represented according to FIGS. 5a-5d. The individual FIGS. 5a to 5d exhibit different manufacturing steps for stacking the individual battery cells 2.1 to 2.n. The representation of FIG. 5a illustrates the first of the individual battery cells 2.1 in a three-dimensional view. The individual battery cell 2.1 is arranged in a prismatic housing and has the two poles 5, 6 as terminal tabs on two of its end faces. In the representation of FIG. 5b, a flexible conductor foil 7 is represented, which is correspondingly connected with the terminal tab 6 and which comprises the semiconductor switching elements (p), (m), (r) as well as other semiconductor switching elements, if necessary, conductor tracks and electronic components. As shown in FIG. 5c, a second of the individual battery cells 2.2 is now stacked on this structure, wherein its terminal tabs 5, 6 are arranged in reverse, so that the terminal tab 6 protrudes forwards and the terminal tab 5 protrudes backwards. The two rear terminal tabs 6, 5, which are no longer recognizable here, clamp the flexible conductor foil between them and contact it accordingly. In the front region, as can be seen in the representation of FIG. 5c, the flexible conductor foil 7 is then folded over again and guided backwards over the now upper individual battery cell 2.2 before, as can be seen in the representation in FIG. 5d, a further individual battery cell 2.3 is stacked in order to clamp the flexible conductor foil 7 between its terminal tab 5 and the terminal tab 6 of the individual battery cells 2.2, before the process is then repeated again until the desired size of the battery is realized via a sufficient number of individual battery cells 2.1 to 2.n.

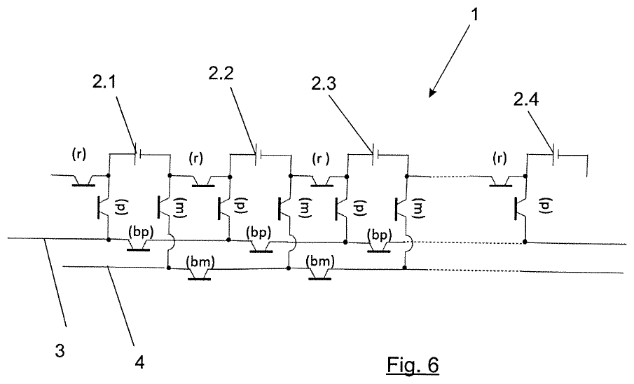

In the representation in FIG. 6, an alternative embodiment of the battery 1 is now represented. Here, too, various individual battery cells 2.1 to 2.n are installed accordingly, and corresponding semiconductor switches are used analogously to the representation in FIG. 1. Again, these are referred to with (r), (p), (m) for each of the individual battery cells 2.1 to 2.n. In addition to these three semiconductor switching elements (p), (r), (m) for each of the individual battery cells 2.1 to 2.n, additional semiconductor switching elements (bp) and (bm) are now also arranged in the region of both busbars 3, 4. These semiconductor switching elements (bp), (bm) are therefore arranged between the respective branches of adjacent individual battery cells 2.1 to 2.n, so that the switching elements (bp) are arranged between the points at which their semiconductor switches (p) are connected with the positive busbar 3. A comparable construction is also realized on the negative busbar 4, so that here the semiconductor switching elements (bm) are arranged between the respective connections of the semiconductor switching elements (m) adjacent to the individual battery cells 2.1 to 2.n.

In addition to the method according to the invention for heating the individual battery cells 2.1 to 2.n, this structure also allows charge equalization between the individual battery cells 2.1 to 2.n to be realized. Furthermore, it is possible to disconnect individual battery cells 2.1 to 2.n from the battery 1, for example if these individual cells are defective, have a very low voltage, have reversed polarity or similar.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for heating a battery constructed from individual battery cells, wherein semiconductor switching elements are arranged between positive and negatives poles of the individual battery cells, the method comprising:
short-circuiting the individual battery cells using the semiconductor switching elements for a first time phase; and
controlling the semiconductor switching elements so that the individual battery cells are not short-circuited for a second time phase,
wherein the first and second time phase alternate,
wherein the first time phase is up to 100 ms, and
wherein the second time phase is between 1 s and 20 s.

10. The method of claim 9, wherein the second time phase is between 5 s and 15 s.

11. The method of claim 9, wherein the second time phase comprises a first time period of relaxation and a subsequent second time period of charging, wherein the subsequent second time period is longer than the first time period.

12. The method of claim 9, wherein an electrical resistance of a respective one of the semiconductor switching elements is selected such that the electrical resistance is lower than an internal resistance of the respective individual battery cell.

13. A traction battery for an at least partially electrically driven vehicle, the traction battery comprising:
an interconnection of individual battery cells, wherein semiconductor switching elements are arranged between positive and negatives poles of the individual battery cells; and
a controller configured to
short-circuit the individual battery cells using the semiconductor switching element for a first time phase; and
control the semiconductor switching elements so that the individual battery cells are not short-circuited for a second time phase,
wherein the first and second time phase alternate,
wherein the first time phase is up to 100 ms, and
wherein the second time phase is between 1 s and 20 s,
wherein there are three semiconductor switching elements coupled to each of the individual battery cells that are configured to individually or jointly connect the respective ones of the individual battery cells to a positive busbar, a negative bus bar, or respective opposite poles of an adjacent individual battery cells,
wherein the semiconductor switching elements are arranged on a flexible conductor foil.

14. The traction battery of claim 13, further comprising:
a respective further semiconductor switching element arranged in the positive busbar and the negative busbar between connections to the semiconductor switching elements, of the respective individual battery cell.

15. The traction battery of claim 13, wherein the individual battery cells are prismatic cells with electric poles arranged on opposite side edges, wherein the electric poles of adjacent individual battery cells are connected via the flexible conductor foil.

16. The traction battery of claim 15, wherein the individual battery cells are stacked with flexible conductor foils placed in between.
